(19) United States
(12) Patent Application Publication
(10) Pub. No.: US 2011/0239995 A1
(43) Pub. Date: Oct. 6, 2011

(54) BLOWER RETROFIT AND METHOD TO IMPROVE DIESEL LOCOMOTIVE PERFORMANCE

(75) Inventor: Francois BERNARD, Doylestown, PA (US)

(73) Assignee: Helm Environmental Solutions, LLC, San Francisco, CA (US)

(21) Appl. No.: 13/073,116

(22) Filed: Mar. 28, 2011

Related U.S. Application Data
(60) Provisional application No. 61/319,249, filed on Mar. 30, 2010.

(51) Int. Cl. F02B 33/36; B23P 6/00

(52) U.S. Cl. 123/559.1; 29/888.011

(57) ABSTRACT

A blower retrofit is provided to reduce diesel locomotive emissions. A method of using the blower retrofit is also described.

### CROSS REFERENCE TO RELATED APPLICATIONS

This application claims the benefit of priority under 35 U.S.C. §119(e) to U.S. Provisional Application No. 61/319,249 filed Mar. 30, 2010 and entitled BLOWER RETROFIT AND METHOD TO IMPROVE DIESEL LOCOMOTIVE PERFORMANCE, the entire contents of which is incorporated herein for all purposes by this reference.

### BACKGROUND OF THE INVENTION

1. Field of the Invention

This invention relates, in general, to the improvement of diesel locomotive performance, and more particularly to blower retrofits incorporating twin-screw superchargers and methods for their use.

2. Description of Related Art

Diesel locomotives are commonplace on American railroads, first entering service in the 1930's. A large number of the diesel locomotives in service today have been in service for decades. For example, the EMD 645 is a family of diesel locomotives that evolved from the earlier EMD 567 family and was built by General Motors' Electro-Motive Division (“EMD”) and was produced from the 1960's and through the 1970's until it was largely replaced by the EMD 710. While the later-produced EMD 710 is turbocharged, both the EMD 645 and the EMD 567 were produced in turbocharged and Roots-blown versions, a large number of which are still in service today.

The largest population that remains in service is the EMD GP38-2, a road switcher locomotive powered by a 645E Roots-blown engine, which is the most popular switching locomotive in the industry. This holds true as very few switching type locomotives have been produced since the late 70's.

Although EMD's two-cycle 567 and 645 engines have proven to be a very reliable engine design in the industry, the Roots-blown engine design has difficulty in properly scavenging the cylinders comparison to their turbocharged counterparts. The Roots-type blower technology has been largely surpassed by evolving turbocharger technology. As such, it is becoming increasingly difficult to service and maintain the Roots-blown locomotives as replacement parts are becoming increasingly difficult to find. Moreover, the locomotives have a very limited amount of space available in the vicinity of the existing blowers which limits the options for replacement of the Roots-blown systems. As such, the population of these blowers is almost extinct.

It would therefore be useful to provide a method and retrofit kit which allows quickly refurbishing the engines of an older Roots-blown locomotives. Moreover, it would be particularly useful to provide such a method and retrofit kit which allows such refurbishing at a local shop or in the field. Further still, it would be useful to provide such a method and retrofit kit which would allow refurbishing other engine assemblies such as marine applications and/or engine-generators (“gen-sets”).

### BRIEF SUMMARY OF THE INVENTION

One aspect of the present invention is directed to a supercharged diesel engine configured to reduce locomotive emissions. The diesel engine includes a blower housing having an inlet and an outlet, a blower support housing fluidly connecting the outlet of the blower housing with an air box of the diesel engine, and

a twin-screw rotor assembly including first and second intermeshing rotors rotatably mounted within the blower housing, and the twin-screw rotor assembly is configured to pump air from the inlet, between the first and second rotors, and to the outlet.

One of the first and second rotors may be a male rotor and the other may be a female rotor. A rightmost one of the first and second rotors revolves counterclockwise and the other revolves clockwise.

The diesel engine may further include a reversing drive assembly for rotating the first and second rotors. A quill shaft may pass through the first rotor and is rotatable relative to the first rotor. The quill shaft may pass through a tubular shaft upon which the first rotor is mounted. The quill shaft may pass through a first timing gear and affixed to a first reversing gear of the reversing drive assembly.

The first reversing gear may be operatively connected to a second reversing gear of the reversing drive assembly. The first and second reversing gears may be operably connected by a drive chain. The second reversing gear may be rotationally affixed to the second rotor. The second reversing gear may be rotationally affixed to a shaft upon which the first rotor is mounted.

The reversing drive assembly may be at least partially supported on an end cap mounted the blower housing. The reversing drive assembly may include first and second reversing gears, and the end cap may rotatably support at least one of the reversing gears.

The diesel engine may further include a blower support housing fluidly connecting the outlet of the blower housing with an air box of the diesel engine.

Another aspect of the present invention is directed to a method of retrofitting a supercharged diesel engine to reduce locomotive emissions. The method includes removing a blower housing from the diesel engine, removing a pair of Roots-type rotors from the blower housing, installing a pair of twin screw rotors in the blower housing, and providing a reversing drive assembly to reverse the rotational direction of the rotors, wherein the blower housing includes an inlet and an outlet, and wherein the twin screw rotors are configured to pump air from the inlet, between the first and second rotors, and to the outlet.

The method may further include machining an inner surface of the blower housing to accommodate the pair of twin screw rotors. The machining the inner surface of the blower housing may include skim cutting an inner wall of the blower housing. The method may further include affixing a quill shaft to a first reversing gear, and the quill shaft may pass through a one of said pair of twin screw rotors. The method may further include operatively connecting the first reversing gear to a second reversing gear rotationally affixed to another of said pair of twin screw rotors. The operatively connecting step may be accomplished by connecting a drive chain to the first and second reversing gears.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a side view of an exemplary locomotive including a diesel engine having dual blower housings mounted thereon.

FIG. 2 is a front view of blower housings similar to those shown in FIG. 1 and mounted on a diesel engine.

FIG. 3 is a cross-sectional view of a conventional Roots-type blower mounted within a blower housing.

FIG. 4 is a schematic view of an exemplary blower assembly configured with screw-type rotors in accordance with the present invention.

FIG. 5 is a isometric view of the exemplary blower assembly of FIG. 4 having a modified drive assembly in accordance with the present invention.

FIG. 6 is an exploded isometric view of the exemplary blower assembly of FIG. 4 having an exemplary drive assembly in accordance with the present invention.

FIG. 7 is a cross-sectional view of the exemplary blower assembly of FIG. 4 showing an exemplary drive assembly in accordance with the present invention, taken along line 7-7 of FIG. 5.

FIG. 8 is a cross-sectional view of the exemplary blower assembly of FIG. 4 showing another exemplary drive assembly in accordance with the present invention, taken along line 7-7 of FIG. 5.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In accordance with the present invention, existing blower assemblies of Roots-blown diesel locomotives are modified by removing the old Roots-type rotors and integrating screw-type rotors. As the existing Roots-type blower population for EMD locomotives has been depleted, existing blower assemblies may be modified to provide their housings with new dimensions by machining the inside of their housing and end plates. Doing so not only maintains the existing envelope available to blower components within the tight special constraints of the locomotive, but also increases the performance of the locomotive by providing higher efficiency screw-type rotors.

Upgrading the locomotives from Roots-type blowers to twin screw blowers also improves combustion by increasing the charge or air pressure within the air box of the diesel engine. Such an upgrade also reduces the parasitic horsepower loss and lowers the overall heat created by the compression, which in turns provides denser air for improved combustion. Overall this greatly reduces the emissions due to improved combustion.

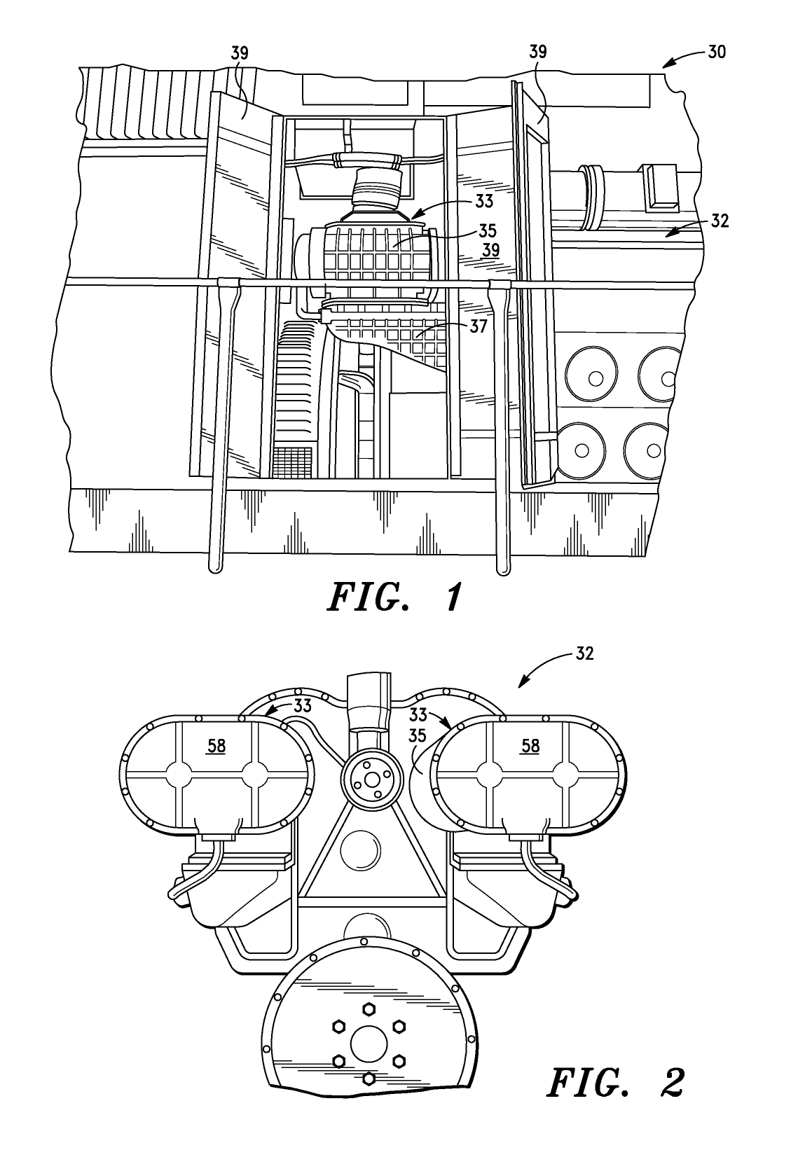

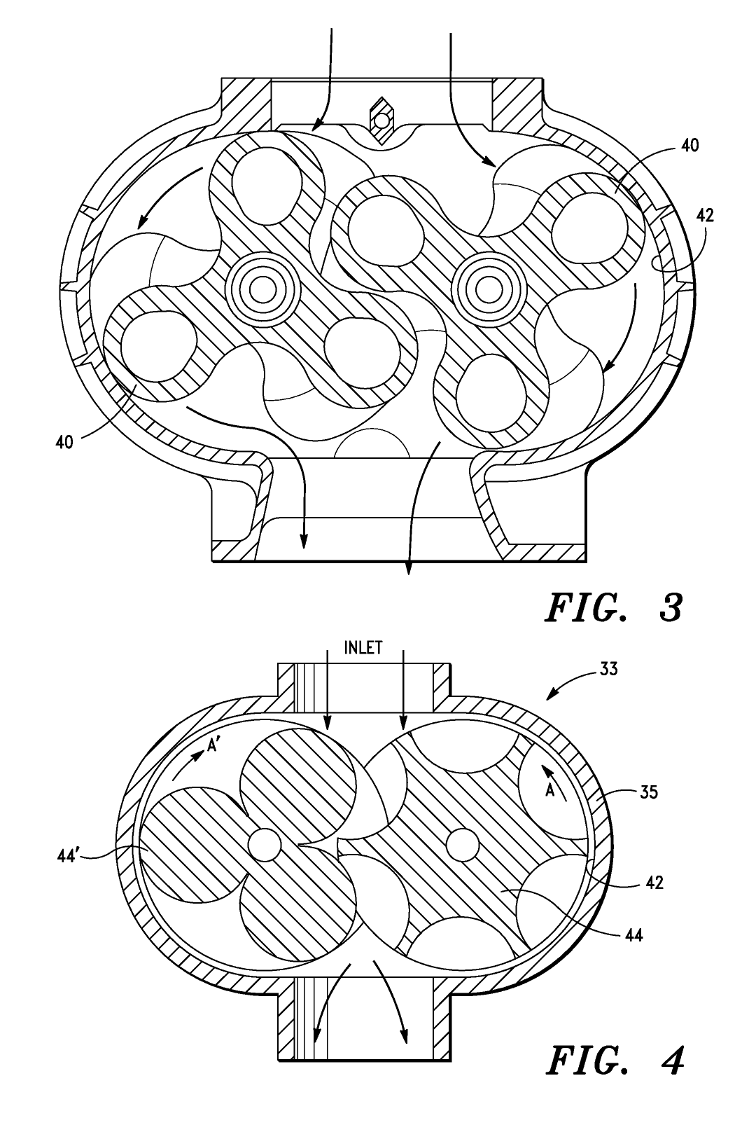

As noted above, a large number of the diesel locomotives in service today have been in service for decades, such as the EMD 645 locomotive, generally indicated by the reference numeral 30 in FIG. 1. For the purposes of discussion, the present invention will be discussed with reference to the EMD 645 locomotive, and in particular, the EMD 645 diesel engine, generally indicated by the reference numeral 32 in FIG. 2, and which is described in the EMD 645E BLOWER-TYPE ENGINE MAINTENANCE MANUAL, 5^{th} Edition, January 1980, the entire content of which is incorporated herein for all purposes by this reference. One will appreciate, however, that the methods, and retrofits of the present invention may be equally suitable for use on other types of diesel locomotives and diesel engines, including but not limited to marine applications and/or engine-generators (“gen-sets”).

The EMD 645 diesel engine 32 is a two-stroke V-form diesel engine in which air is drawn into its cylinders through air boxes extending substantially the length of the engine, and fuel is supplied to the cylinders by fuel injection in a known manner. In cases where the diesel engine is supercharged, the engine is provided with one or more blower assemblies 33 including blower housings 35 mounted on the rear end of the engine (but typically facing forward with respect to the locomotive) in conjunction with a blower support housing 37 that directs charged air from the blower into a respective air box. The blowers and other portions of the diesel engine may be accessed by one or more access doors 39 in a known manner.

With reference to FIG. 3, the conventional Roots-type blower, which are presently found on EMD 645E engines, includes 3-lobed rotors 40 which circumferentially compress and pump inlet air between the rotors and an inner wall 42 of blower housing as the rotors rotate outwardly. As the 3-lobed rotors must maintain a fair clearance between each other and the inner wall, such Roots-type blowers can pump air across only a limited pressure differential. Also, since air is compressed between the lobes and the inner wall, Roots-type blowers are also subject to significant friction and heat generation. In fact, if the Roots-type blower is used outside its specification pressures, the compression of the air may generate sufficient heat to expand the lobes and cause jamming thereby damaging the blower.

While Roots-type blowers are capable of compressing large volumes of air, they may only achieve moderate compression. The Roots-type lobed helical rotors provide scavenging air at 3 to 5 psi above atmospheric into the air boxes and to each of the engine cylinder's intake ports. While this may improve performance relative to non-supercharged engines, engines equipped with Roots-type blowers have difficulty in scavenging the cylinders properly as compared to their turbocharged counterparts.

In order to overcome the limitations of conventional Roots-type blowers, diesel engine 32 is modified in accordance with the present invention to integrate twin screw rotors. In particular, the blower housing is modified such that the conventional Roots-type rotors are replaced with higher-efficiency twin screw rotors. By modifying the existing blower housings as such, one can maintain the dimensional envelope of existing Roots-type blower configurations and improve the effectiveness of the diesel engines. In particular, utilizing twin screw rotors in accordance with the present invention increases the operating supercharged pressure of the diesel engines thereby increasing the charge within the air boxes and cylinders thereby improving combustion of the diesel engines. Moreover, replacing the conventional Roots-type rotors with twin-screw rotors in accordance with the present invention also reduces parasitic horsepower of the blower and lowers the heat created by compression within the blower, which in turns provides denser air that also serves to improve combustion. Overall, the twin-screw rotor configuration of the present invention greatly reduces the emissions due to a much improved combustion.

In accordance with the present invention, and with reference to FIG. 4, blower housing 35 is modified to utilize twin-screw rotors 44, 44′ within the existing housing. The air path effected by the twin-screw rotors is now straight through the housing and the rotors, as shown by the arrows in FIG. 4, thereby eliminating friction between the rotors and inner wall 42 of the blower housing common to Roots-type rotors. In order to accomplish this, the rotation of the rotors must be reversed, as is discussed in greater detail below.

The Roots-type rotors must first be removed from the blower housing, and blower housing 35 must then be prepared for use with new twin screw rotors 44, 44′. In particular, the blower housing is removed from diesel engine 32 and inner wall 42 is machined to accommodate the dimensions of the twin screw rotors and to provide a new wall finish. Namely, the inner wall of the blower housing is machined to correspond with the outer dimensions of the twin screw rotors and skim cut to provide a better finish and closer tolerances. For example, the inner wall may be dimensioned and skim cut 0.030″. One will appreciate that the inner wall of the blower housing may be dimensioned and skim cut with computer numerical controlled (CNC) machining and/or other suitable means.

One will appreciate that twin screw rotors 44, 44′ may be fabricated to fit within the general dimensions of blower housing 35. One will also appreciate that various designs may be utilized. For example, the twin screw rotors may be similar to those manufactured by Lysholm Technologies AB of Stockholm, Sweden, or Kenne Bell, Inc. of Rancho Cucamonga, Calif. In various embodiments, the rotors are configured and dimensioned for use within the existing blower housings. One will appreciate, however, that new blower housings may be manufactured or fabricated provided that they are configured and dimensioned to be mounted on engine 32 and blower support housing 37.

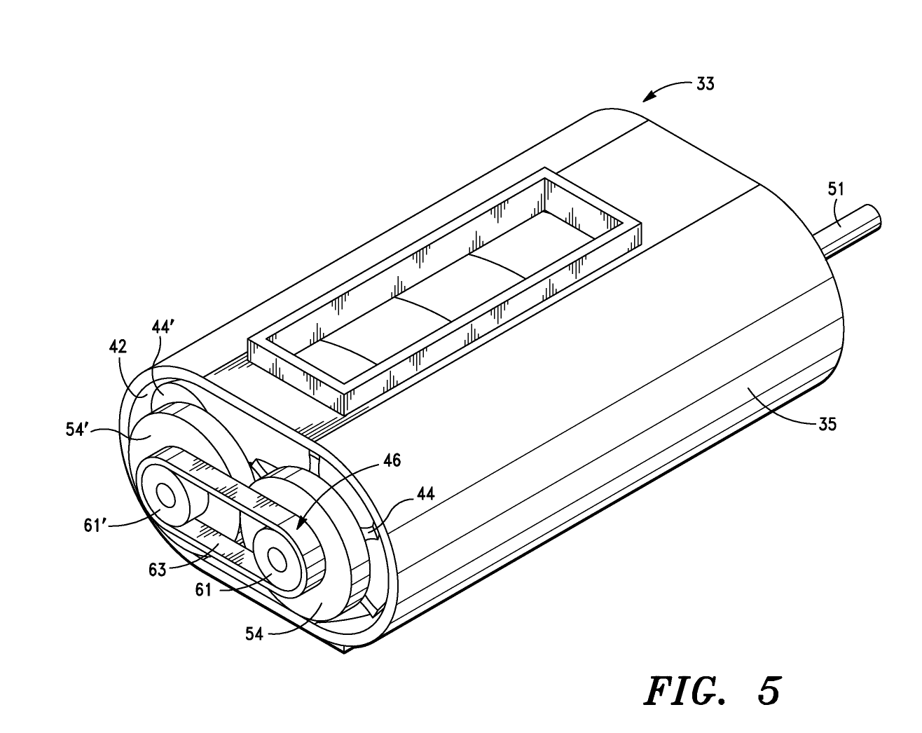

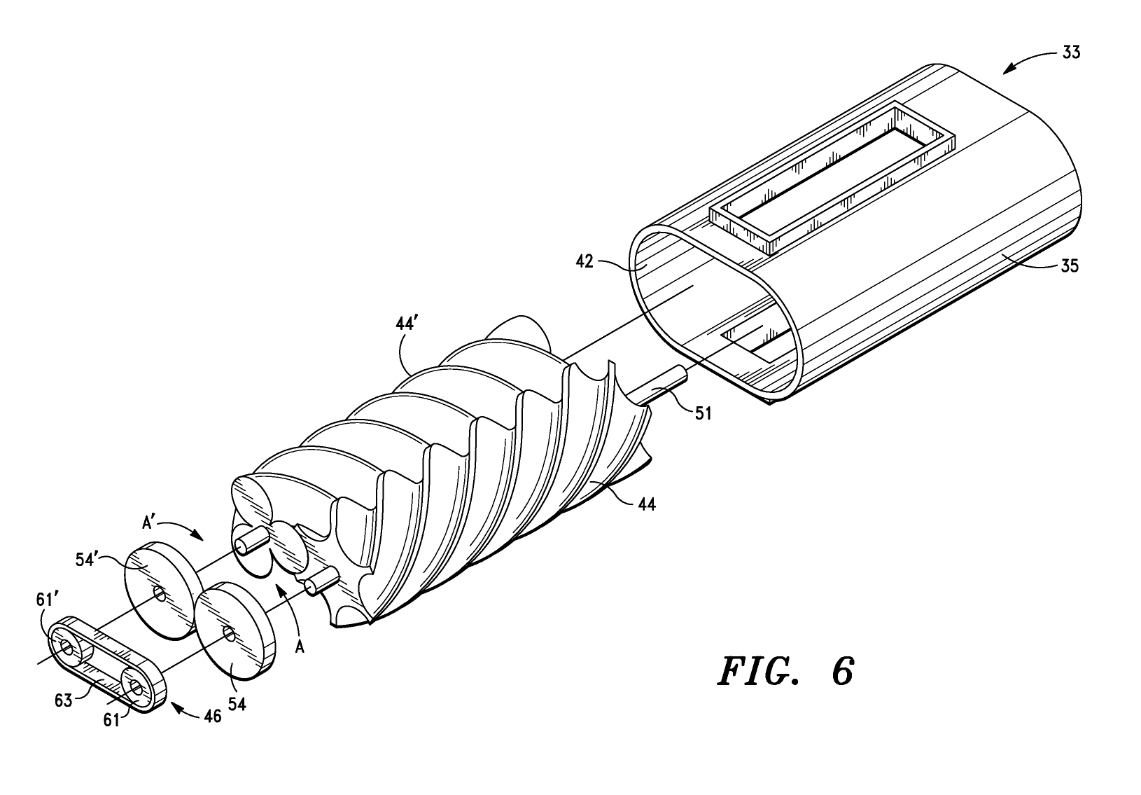

As the twin screw rotors 44, 44′ of the present invention operate in a fundamentally different way than the conventional Roots-type rotors, the drive assembly must be reconfigured. Namely, the twin screw rotors of the present invention rotate toward one another as indicated by the arrows A, A′ in FIG. 4. Accordingly, a rotation-change drive assembly 46 must be provided to properly drive the twin screw rotors, as shown in FIG. 5 and FIG. 6.

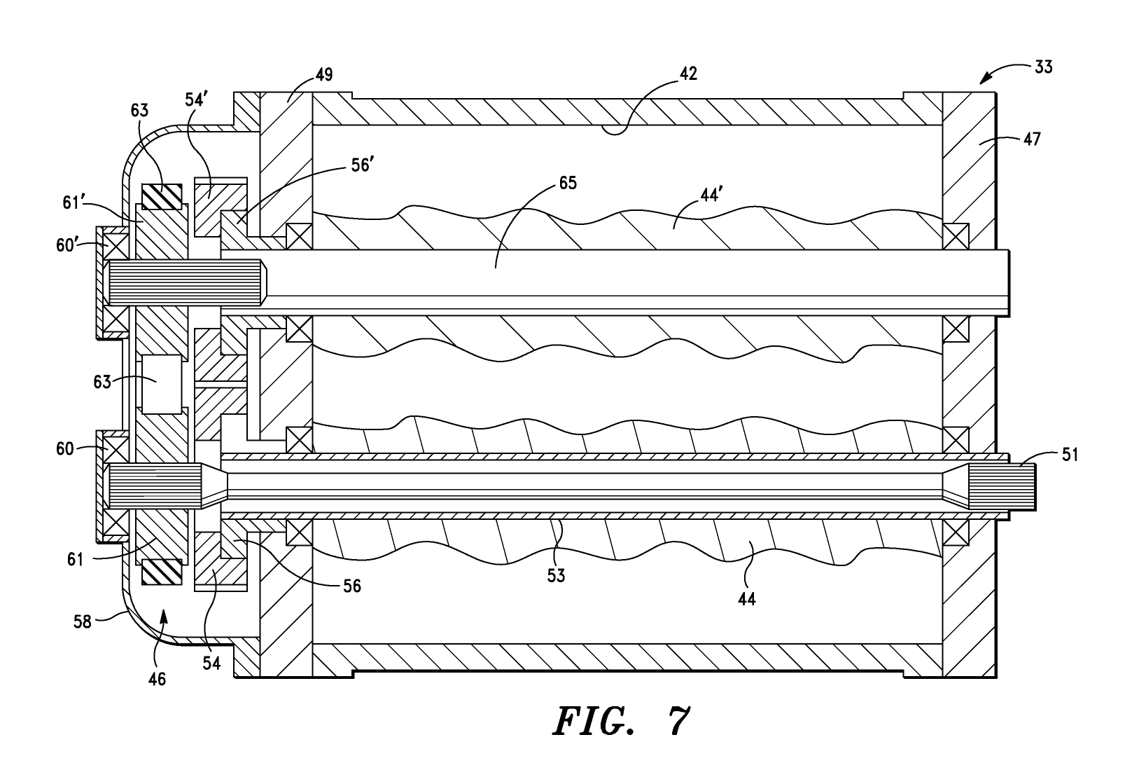

With reference to FIG. 7, screw rotors 44, 44′ are rotatably supported on a mounting plate 47, which is mounted on the rear end of the diesel engine, and an end plate 49 by suitable bearing means. A quill shaft 51 is driven by blower drive gear in the camshaft drive train of the diesel engine in an otherwise conventional fashion. The quill shaft passes through a tubular shaft 53 upon which a screw rotor 44 is mounted. In various embodiments, the screw rotor may be pressed on or otherwise affixed to the tubular shaft, however, one will appreciate that the rotor and tubular shaft may be monolithically formed.

In contrast to the conventional Roots-type blower configuration, quill shaft 51 passes through a timing gear 54, which is rotationally affixed to tubular shaft 53 of screw rotor by a mounting flange 56, without engaging the timing gear. Instead, the quill shaft is supported on end cap 58 by a bearing 60 or other suitable bearing means including but not limited to roller bearings, Babbitt bearings and/or materials, etc., and rotationally affixed to a respective reversing gear 61. The reversing gear is operably attached to a corresponding reversing gear 61′ by a drive chain or drive belt 63 in order to drive the opposite twin screw rotor 44′. One will appreciate that a suitable chain tensioner or binder may be utilized to prevent the drive chain or belt from slipping in an otherwise conventional manner.

In particular, reversing gear 61′ is also rotatably supported on end cap 58 by a bearing 60, or other suitable bearing means but not limited to roller bearings, Babbitt bearings and/or materials, etc., and rotationally affixed to rotor shaft 65 of the opposite screw rotor 44′. In various embodiments, a splined shaft 67 may be provided to rotationally affix reversing gear reversing gear 61′ to screw rotor 44′. One will appreciate, however, that other suitable means may be utilized to rotationally affix the gear to the rotor. For example, reversing gear 61′ may be mounted directly on rotor shaft 65 if the shaft protrudes sufficiently through end plate 49.

The standard timing gears may be reused, however in contrast to conventional Roots-type blowers, it is now timing gear 54′ that drives timing gear 54, thus effecting the inward rotation of twin screw rotors 44, 44′ as is shown in FIG. 4 through FIG. 6.

As screw rotors 44, 44′ generally have a different number of lobes, for example, the male rotor may have four lobes, and the female rotor have five lobes, the timing will differ from that of existing Roots-type rotors, which each have three lobes. One will appreciate that the timing gears may be replaced with other timing gears to select an appropriate drive ratio. One will also appreciate that the reversing gears may be configured to select an appropriate drive ratio. Generally, the female rotor will have a greater number of lobes than the male rotor. One will appreciate that the male rotor may have 3, 4, 5 or more lobes, while the female rotor may have 4, 5, 6 or more lobes.

In various embodiments, end cap 58 includes sufficient room to accommodate the reversing gears and drive chain, however, one will appreciate that the end cap may be modified or replaced with a suitable end cap. For example, a new end cap maybe necessary to provide sufficient structural integrity to support bearings 60, 60′.

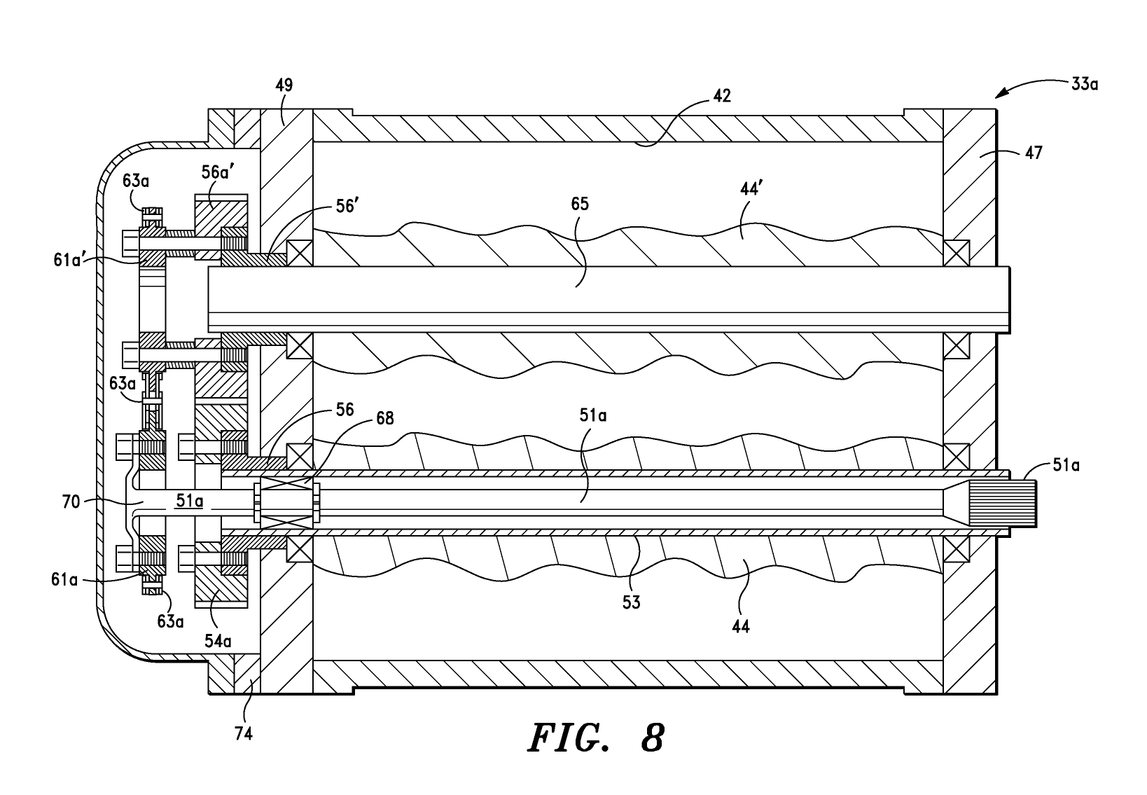

In another exemplary embodiment of the present invention shown in FIG. 8, blower assembly 33a is similar to blower assembly 33 described above. Like reference numerals have been used to describe like components of blower assembly 33a and blower assembly 33. In operation and use, blower assembly 33a is used in substantially the same manner as blower assembly 33 discussed above.

In various embodiments, quill shaft 51a passes through timing gear 54a without engaging the timing gear like the quill shaft described above. However, in various embodiments, the quill shaft may be rotatably supported within a tubular shaft 53 by a needle bearing 68, as shown in FIG. 8. One will appreciate that other suitable bearing means may be used including but not limited to roller bearings, Babbitt bearings or materials, etc. The quill shaft may be rotationally affixed to respective reversing sprocket 61a via a sprocket mounting plate 70 that is bolted to the reversing sprocket. One will appreciate that other suitable means may be utilized to rotationally affix the quill shaft to the reversing sprocket. For example, the reversing sprocket may be keyed to the sprocket mounting plate, welded to the sprocket mounting plate, integrally formed with to the sprocket mounting plate, or affixed by other suitable means.

Reversing sprocket 61a is operably attached to a corresponding reversing sprocket 61a′ by a drive chain 63a in order to drive the opposite twin screw rotor 44′. In this embodiment, a drive chain is utilized as the reversing sprockets and timing gears operate within an oil bath. However, one will appreciate that driving chains, driving belts and/or other suitable driving means may be utilized to transmit drive power from the quill shaft to rotor shaft 65. In any event, one will again appreciate that a suitable chain tensioner or binder may be utilized to prevent the drive chain from slipping in an otherwise conventional manner.

Reversing gear 61a′ rotationally affixed to rotor shaft 72 of the opposite screw rotor 44′. In various embodiments, the reversing gear may be bolted to timing gear 54a′ and/or mounting flange 56′ to rotationally affix reversing gear reversing gear 61a′ to rotor shaft 65 and screw rotor 44′. One will appreciate, however, that other suitable means may be utilized to rotationally affix the gear to the rotor. For example, reversing gear 61′ may be mounted directly on rotor shaft 65 if the shaft protrudes sufficiently through end plate 49.

Again, the standard timing gears may be reused, however in contrast to conventional Roots-type blowers, it is now timing gear 54′ that drives timing gear 54, thus effecting the inward rotation of twin screw rotors 44, 44′ as is shown in FIG. 4 through FIG. 6.

As noted above the end cap may have sufficient room to accommodate the reversing sprockets and drive chain. However, one will appreciate that in various embodiments, end cap 58a may be provided with an end cap spacer 74 to provide additional clearance, if necessary, for the reversing sprockets and drive chain.

Advantageously, the method and retrofit of the present invention allows for retrofitting older Roots-blown diesel locomotives with twin-screw superchargers that are designed to overcome many of the shortcomings of the existing and aging Roots-type blowers. For example, twin screw rotors are capable significantly increasing the charge within the engines air boxes while reducing the discharge temperatures. For example, twin screw rotors may effectively double the pressure boost while decreasing the discharge temperature.

As such, the method and retrofit of the present invention allows for retrofitting older diesel locomotives for use in various markets, including California, Texas, as well as other regions and urban areas and special districts where emissions requirements may be more stringent. In fact, the method and retrofit of the present invention may be used in conjunction with other means to reduce emissions, such as those disclosed in copending U.S. Patent Application No. 61/256,907 entitled METHOD AND RETROFIT KIT TO REDUCE LOCOMOTIVE EMISSIONS AND SPEED SENSOR THEREFOR.

For convenience in explanation and accurate definition in the appended claims, the terms “inner” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A supercharged diesel engine configured to reduce locomotive emissions, the diesel engine comprising:
a blower housing having an inlet and an outlet;
a blower support housing fluidly connecting the outlet of the blower housing with an air box of the diesel engine; and
a twin-screw rotor assembly including first and second intermeshing rotors rotatably mounted within the blower housing, the twin-screw rotor assembly being configured to pump air from the inlet, between the first and second rotors, and to the outlet.

2. A supercharged diesel engine according to claim 1, wherein one of the first and second rotors is a male rotor and the other is a female rotor.

3. A supercharged diesel engine according to claim 1, wherein a rightmost one of the first and second rotors revolves counterclockwise and the other revolves clockwise.

4. A supercharged diesel engine according to claim 1, wherein the diesel engine further comprises a reversing drive assembly for rotating the first and second rotors.

5. A supercharged diesel engine according to claim 4, wherein a quill shaft passes through the first rotor and is rotatable relative to the first rotor.

6. A supercharged diesel engine according to claim 5, wherein the quill shaft passes through a tubular shaft upon which the first rotor is mounted.

7. A supercharged diesel engine according to claim 4, wherein the quill shaft passes through a first timing gear and affixed to a first reversing gear of the reversing drive assembly.

8. A supercharged diesel engine according to claim 7, wherein the first reversing gear is operatively connected to a second reversing gear of the reversing drive assembly.

9. A supercharged diesel engine according to claim 8, the first and second reversing gears are operably connected by a drive chain.

10. A supercharged diesel engine according to claim 9, wherein the second reversing gear is rotationally affixed to the second rotor.

11. A supercharged diesel engine according to claim 10, wherein the second reversing gear is rotationally affixed to a shaft upon which the first rotor is mounted.

12. A supercharged diesel engine according to claim 4, wherein the reversing drive assembly is at least partially supported on an end cap mounted the blower housing.

13. A supercharged diesel engine according to claim 12, wherein the reversing drive assembly includes first and second reversing gears, and the end cap rotatably supports at least one of the reversing gears.

14. A supercharged diesel engine according to claim 1, wherein the diesel engine further comprises a blower support housing fluidly connecting the outlet of the blower housing with an air box of the diesel engine.

15. A method of retrofitting a supercharged diesel engine to reduce locomotive emissions, the method comprising:
removing a blower housing from the diesel engine;
removing a pair of Roots-type rotors from the blower housing;
installing a pair of twin screw rotors in the blower housing; and
providing a reversing drive assembly to reverse the rotational direction of the rotors;
wherein the blower housing includes an inlet and an outlet, and wherein the twin screw rotors are configured to pump air from the inlet, between the first and second rotors, and to the outlet.

16. A method of retrofitting a supercharged diesel engine according to claim 15, wherein the method further comprises machining an inner surface of the blower housing to accommodate the pair of twin screw rotors.

17. A method of retrofitting a supercharged diesel engine according to claim 16, wherein the machining the inner surface of the blower housing includes skim cutting an inner wall of the blower housing.

18. A method of retrofitting a supercharged diesel engine according to claim 15, wherein the method further comprises affixing a quill shaft to a first reversing gear, wherein the quill shaft passes through a one of said pair of twin screw rotors.

19. A method of retrofitting a supercharged diesel engine according to claim 18, further comprising operatively connecting the first reversing gear to a second reversing gear rotationally affixed to another of said pair of twin screw rotors.

20. A method of retrofitting a supercharged diesel engine according to claim 19, wherein the operatively connecting step is accomplished by connecting a drive chain to the first and second reversing gears.
